(19) United States
(12) Patent Application Publication
(10) Pub. No.: US 2016/0349113 A1
(43) Pub. Date: Dec. 1, 2016

(54) CHARACTERIZATION OF ABSOLUTE SPECTRAL RADIANCE OF AN UNKNOWN IR SOURCE

(71) Applicant: Raytheon Company, Waltham, MA (US)

(72) Inventor: Steven F. Cook, Tucson, AZ (US)

(21) Appl. No.: 14/724,247

(22) Filed: May 28, 2015

(51) Int. Cl. G01J 3/453; G01J 3/02

(52) U.S. Cl. CPC G01J 3/453; G01J 3/0275; G01J 3/027

(57) ABSTRACT

The absolute spectral radiance of an unknown IR source is measured by bracketing the radiance measurements of the source over a spectral band with radiance measurements of a characterized blackbody at different temperatures. The absolute spectral radiance (or effective temperature) is calculated for the blackbody and paired with the relative radiance measurements. The absolute spectral radiance for the unknown IR source is derived via interpolation. The use of a characterized plate blackbody and a FTIRS allows for rapid and accurate characterization of the unknown IR source across a spectral band.

### BACKGROUND OF THE INVENTION

1. Field of the Invention

This invention relates to the measurement and characterization of absolute spectral radiance of an unknown infrared (IR) source.

2. Description of the Related Art

The nature of energy and matter is that an object (matter) absorbs energy as a function of its environment. That absorbed energy causes the object to change its thermodynamic temperature. The object will then emit energy based not on the energy that was absorbed but on its temperature. If the object combines matter, surface and shape so that it emits the maximum energy possible it is called a “Planckian Radiator” and is an artifact used extensively in radiometry. The energy of a perfect blackbody exactly follows “Planck's Blackbody Equation”.

$${L}_{λ} = \frac{1}{π} \times \frac{C 1}{{λ}^{5} \times ( {e}^{\frac{C 2}{λ \times K}} - 1 )}$$

where C1 and C2 are Planck's constants 1 and 2, λ is wavelength, K is the thermal temperature of the blackbody in degrees Kelvin and L_{λ} is the absolute radiance as a function of wavelength. Sources that approximate Planck's equation are called “greybodys”, those that come close are called “blackbodies”. Almost as important to science is the fact the perfect blackbody will completely absorb any optical radiation entering it, allowing nothing to come back from such a source but its thermally defined emission.

By measuring the optical radiation being emitted by a material we can obtain profound knowledge about the chemical makeup, thermodynamic temperature and shape of the object. The measurement providing the most information about the energy being emitted by an object is that of absolute radiance. Measured radiance can be either absolute or relative. The difference between absolute and relative radiance is in the unit of measurement. Absolute radiance is defined in units of watts per centimeter squared, per unit solid angle (steradian) and per unit frequency. Relative radiance meets the spatial requirements of radiance but the power is unknown. Absolute ambient radiance is needed when measurements of transmittance, reflectance and emissivity are being derived. When the spectroradiometer has sensitivity below ambient, relative ambient radiance is also required. Absolute radiance also requires that wavelength be defined either at a discreet point or over a range.

The measurement of absolute radiance is defined best by looking at the units. Watts denote a unit of heat or power. Centimeters squared indicates it is a function of area. Steradian (sr) is a unit of solid angle, indicating how the energy is dispersing as it leaves the object. Wavelength tells us the “color” of the energy, but actually visible light is only a very small subset of optical radiation.

Instruments that make measurements of optical power are called optical power-meters. Radiometers are the term for most instruments that measure radiance. Radiance measurements must be made with a device that restricts the collection of energy so that a controlled “field of view” (FOV) is generated. This was originally done with a tube, but modern radiometers use optics. The range of wavelengths is determined using a filter, or by some other wavelength limiting device. An absolute radiometer is one whose indication is in Watts. So the result can be related directly back to Planck's Blackbody equation, that the amplitude can tell you the power in watts per unit area, solid angle and wavelength.

The term “spectroradiometer” refers to a class of relative radiance meters that provide not one value but an array of values separated equally in wavelength. Such an instrument has the added value of allowing only a portion of the spectral range it measures over, to be defined, making it far more versatile. This can be done by rotating through several filters, stepping a monochromator or Continuously Variable “wavelength” Filter (CVF) or using a Michelson interferometer. Measurements using a Michelson interferometer are also called Fourier Transform Infra-Red (FTIR). FTIR Spectroradiometers take advantage of the inherent wavelength accuracy of a Michelson interferometer for use in applications such as spectroscopy, atmospheric sounding and optical component characterization. The conversions of relative radiance values to absolute use an absolute filter based radiometer to approximate the temperature of a source. The relative spectral array is draped across the interval that is the range of the absolute radiometer and using Planck's equation, the absolute radiance is approximated.

Typically, the absolute radiance of an unknown source is measured over a single defined band. A blackbody characterized over the defined band (single emissivity value) is used to calibrate a radiometer for that band. The radiometer is then used to measure the absolute radiance of the unknown source. This provides only a single absolute radiance measurement over an interval of wavelengths.

The Navy Primary Standards Laboratory (NPSL) developed a method of FTIR Calibration of Blackbodies, “FTIR SPECTRAL CALIBRATION OF

BLACKBODIES” Measurement Science Conference 2010. This methodology is limited to the calibration of cavity blackbodies, which are very close to perfect blackbodies having nearly 100% emissivity e.g., >99% typically, and relies on the near perfection of the cavity blackbodies. A pyrometer is used the measure the temperature of the cavity blackbody over a narrow spectral band. The measured temperature is input to Planck's equation to determine a value of absolute radiance over the narrow spectral band. An FTIR spectroradiometer measures the relative radiance from the cavity blackbody at multiple wavelengths over a much broader spectral band. Because the cavity blackbody is nearly perfect, the absolute radiance in the narrower spectral band can be used to provide a correction term for the broader spectral band to scale the relative radiance up or down to an absolute spectral radiance. This approach is limited to the characterization of sources, such as a cavity blackbody, that are a nearly perfect blackbody.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention provides a characterization of absolute spectral radiance of a source as a function of wavelength.

In an embodiment, the relative radiance Rs(λ) of the unknown source is measured at a plurality of wavelengths over a spectral band. The relative radiance Rbbₜᵢ(λ) of a characterized blackbody is measured at the plurality of wavelengths over the spectral band at different blackbody temperatures such that the measurements bracket those of the unknown source over the spectral band. At each wavelength, the absolute radiance Lbbₜᵢ(λ) of the characterized blackbody is calculated at each of the different temperatures and paired with the measured relative radiance Rbbₜᵢ(λ). The absolute radiances Lbbₜᵢ(λ) are interpolated to derive an absolute radiance Ls(λ) for the unknown source at its measured relative radiance.

In an embodiment, the absolute radiance is calculated as the sum of the direct radiance emitted by the blackbody (function of thermal temperature of the blackbody) and the ambient radiance (function of ambient temperature) reflected off of the blackbody.

In an embodiment, the absolute radiance of the characterized blackbody is first converted to an effective temperature. The effective temperatures are interpolated to derive an effective temperature of the unknown source. The absolute radiance of the unknown source is calculated from its effective temperature. Although this requires additional computation, it may be done because it linearizes the measurement of the characterized blackbody, which improves the accuracy of the interpolation.

In an embodiment, the characterized blackbody radiance is measured at different temperatures that provide at least two sets of measurements above and two sets of measurements below the relative radiance of source temperature across the spectral band. The number of blackbody temperatures is directly related to the accuracy of the interpolation, the greater the number of data points the more accurate the estimate of the absolute radiance of the source. Depending upon the number of data points, a linear, piecewise linear or non-linear (such as Rational, Lagrange, cubic or cubic hermite) interpolation may be used.

In an embodiment, the measurements of relative radiance are made with a spectroradiometer such as a Fourier Transform Infrared Spectroradiometer (FTIRS).

In an embodiment, the characterized blackbody is a characterized plate blackbody. The plate blackbody is characterized by an emissivity correction array that was calibrated against a liquid bath blackbody.

In an embodiment, the plate blackbody is characterized by comparing the relative radiances of an almost perfect Planckian radiator and the plate blackbody and correcting for the offset that exists in the “ambient” portion of the energy distribution to generate a correction that applies over a fairly broad range of temperatures allowing the exact radiance emitted from the blackbody to be known. More particularly, the same thermometer is used to set a liquid bath blackbody to a specified temperature and to adjust the thermal temperature of a plate blackbody to equal the temperature of the liquid bath blackbody. The relative radiance is measured at a plurality of wavelengths over a specified spectral band of an ambient plate, the liquid bath blackbody and the plate blackbody. At each wavelength, the relative radiance of the ambient plate is subtracted from the relative radiances of the liquid bath blackbody and the plate blackbody, respectively, to provide adjusted liquid bath and plate blackbody relative radiances. The adjusted plate blackbody relative radiance is divided by the adjusted liquid bath blackbody radiance to provide an absolute emissivity to characterize the plate blackbody. The absolute emissivities are output as a correction array for the plate blackbody such that the plate blackbody approximates the characterization of the liquid bath blackbody.

In an embodiment, a characterized plate blackbody and an FTIRS are used to characterize the absolute spectral radiance of the unknown source. This combination allows the source to be characterized with high spectral resolution (10 nm or better) over a broad spectral range (NIR, MIR and LWIR) in a short period of time e.g., approximately 2 hours.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a block diagram of an embodiment of a test configuration utilizing a characterized plate blackbody and FTIRS to measure absolute spectral radiance of an unknown IR source, FIG. 2 is a flow diagram of an embodiment for using the test configuration to measure absolute spectral radiance of the unknown source;

FIG. 3 is a plot of the radiance measurements of the characterized plate blackbody and the unknown IR source;

FIG. 4 is a plot of temperature vs. measured radiance illustrating the interpolation of the characterized plate blackbody effective temperature (absolute radiance) to derive the effective temperature (absolute radiance) of the unknown IR source;

FIG. 5 is a plot of the absolute spectral radiance of the unknown IR source;

FIG. 6 is a block diagram of an embodiment of a test configuration utilizing a liquid bath blackbody to characterize a plate blackbody; and

FIG. 7 is a flow diagram of an embodiment for using the test configuration to characterize the plate blackbody.

### DETAILED DESCRIPTION OF THE INVENTION

The present invention provides a characterization of absolute spectral radiance of an unknown IR source as a function of wavelength. The source may be characterized over all or part of the Near Infrared (NIR, 1 to 3 μm), the Mid Infrared (MIR, 3 to 5 μm) and Long-wave Infrared (LWIR, 5 to 15 μm). This characterization is good for radiance measurements approximated by blackbody temperatures from 265 to 1273 Kelvin and higher.

In certain embodiments, the characterization utilizes a characterized plate blackbody and FTIRS to quickly and accurately measure the absolute spectral radiance of the unknown source. For example, an unknown source may be characterized across an IR band from 3-14.5 μm at wavelength resolutions of approximately 10 nm in less than two hours.

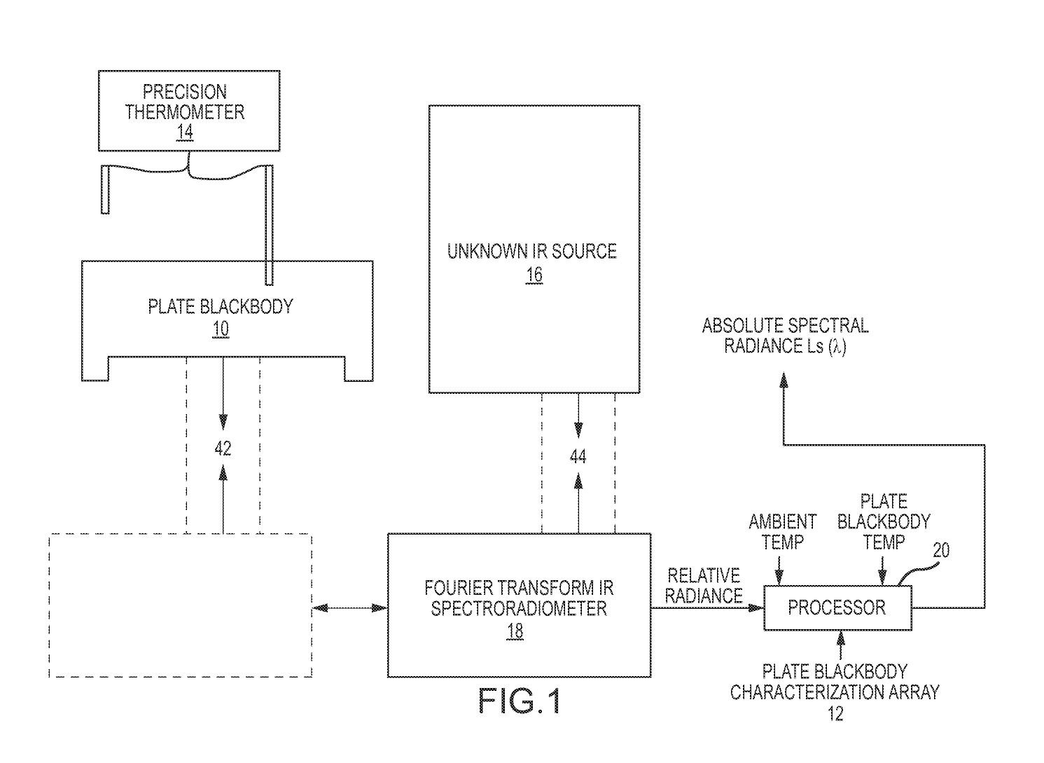

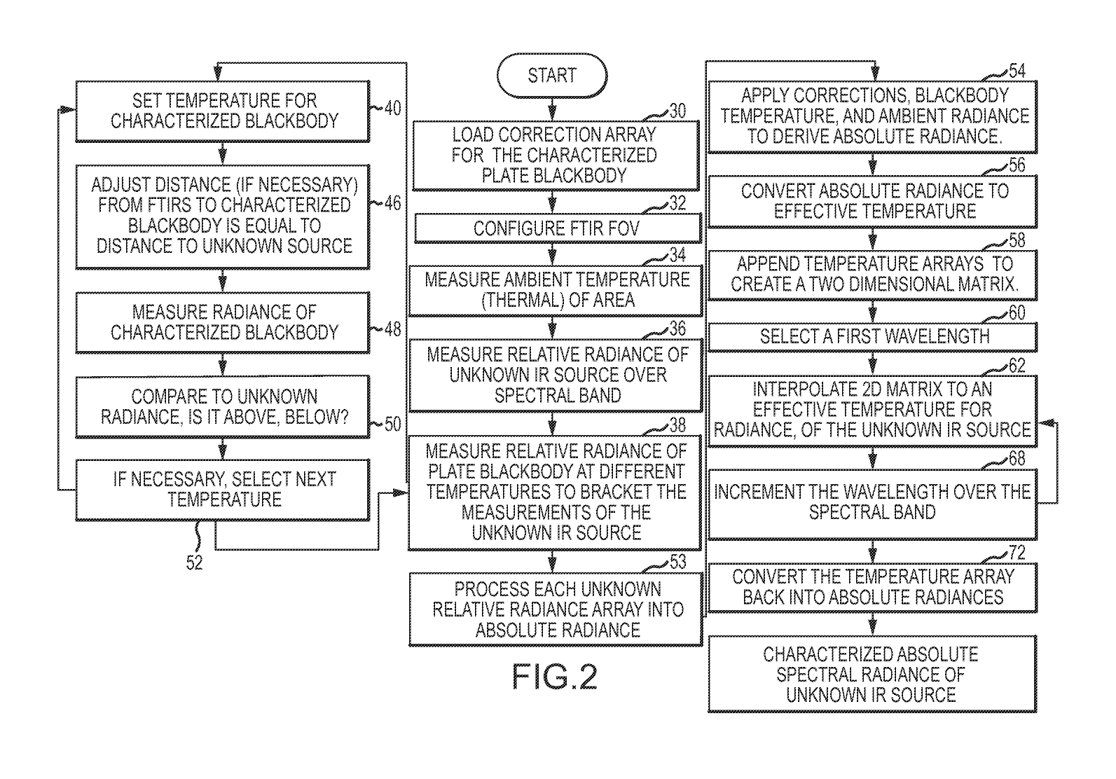

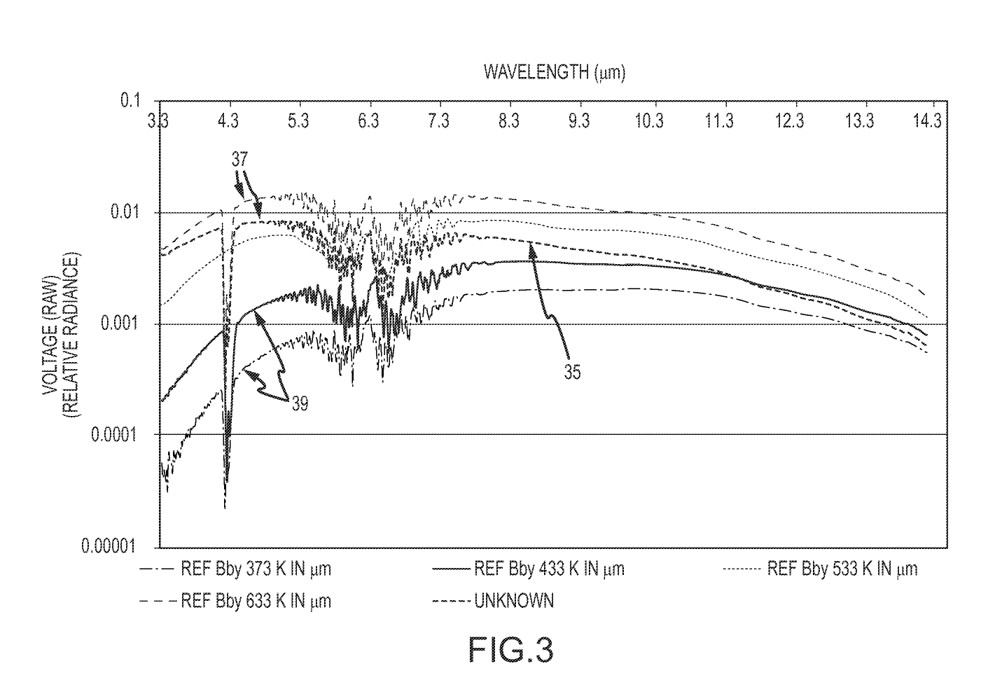

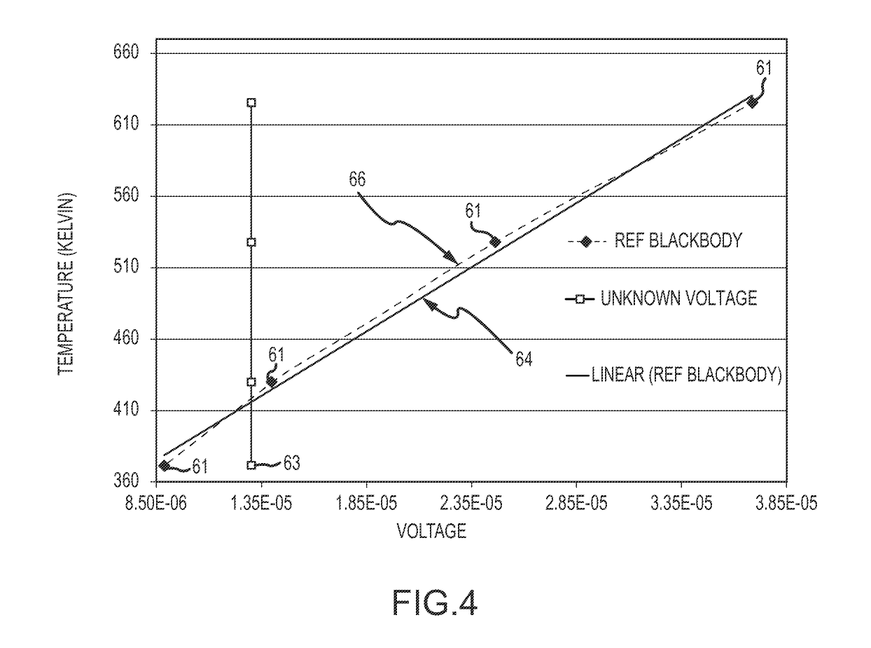

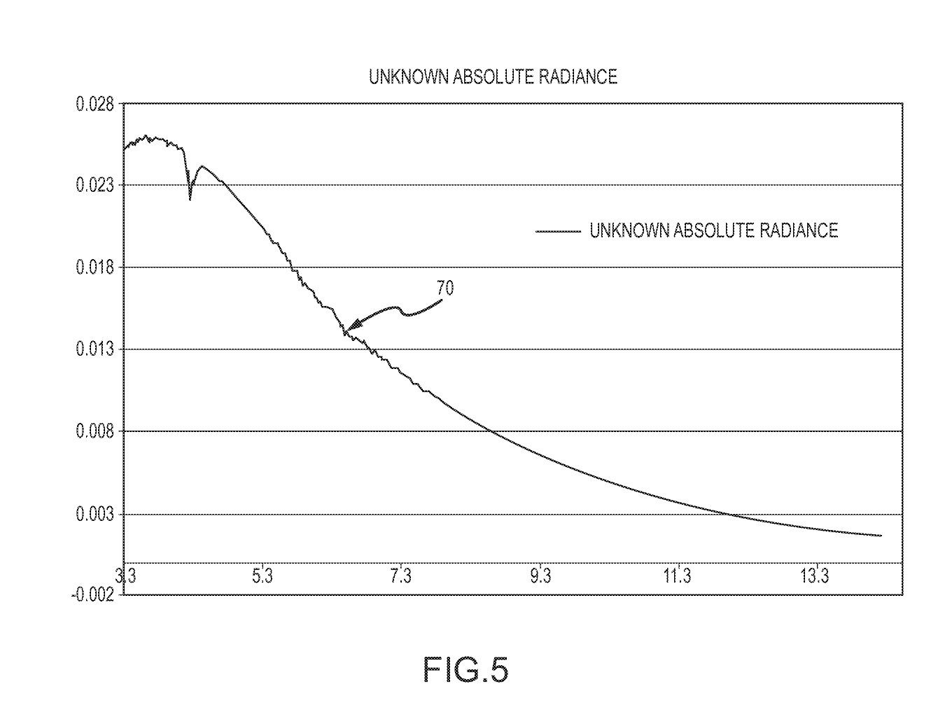

Referring now to FIGS. 1-5, in an embodiment a test configuration comprises a plate blackbody 10 and its characterization array 12, a thermometer 14 configured to measure both an ambient temperature and a plate blackbody temperature, an unknown IR source 16, an FTIRS 18 to measure the relative radiances of the plate blackbody 10 and unknown IR source 16 and a processor 20 configured to process measured temperatures and relative radiances to characterize the absolute spectral radiance of the unknown IR source across a spectral band.

Unknown IR source 16 may be an inactive source such as a blackbody or an active source such as laser source used as part of the guidance system on a missile. The source may have a range of operating conditions e.g., different thermal temperatures of the source at which to characterize the absolute spectral radiance of the source. The methodology described below can be repeated to characterize the source at different operating conditions.

The correction array for the characterized plate blackbody 10 is loaded into processor 20 (step 30). The FTIRS 18 is configured such that both the unknown IR source and plate blackbody overfill the FOV of the FTIRS (step 32). Thermometer 14 measures the ambient temperature (K_{amb}) (step 34). FTIRS 18 is positioned to measure a radiance 35 (relative radiance Rs(λ)) of the unknown IR source 16 at a specified spectral resolution (e.g., 10 nm) over a spectral band (e.g., 3-14.5 microns) (step 36).

FTIRS 18 is repositioned to measure the radiance (relative radiance Rbb(λ))(K_{bb}¹)) of plate blackbody 10 at the spectral resolution over the spectral band at different thermal blackbody temperatures K_{bb}¹, K_{bb}². . . to bracket the relative radiance Rs(λ) of the unknown IR source over the spectral band (step 38). It is typically preferable to take at least two measurements 37 above and two measurements 39 below the relative radiance Rs(λ) 35 of the unknown IR source over the spectral band.

To bracket the measurements of the unknown IR source, the thermal temperature of the plate blackbody 10 is set at an initial value (step 40). The plate blackbody may have an integrated or separate heating element to set its temperature. The initial value may be based on information known about characteristic of the IR source or not. A distance 42 from the FTIRS to the plate blackbody 10 is optionally set equal to the distance 44 from the FTIRS to the unknown IR source (step 46). This is done in order to facilitate removing the affects of water vapor from the measurements. The FTIRS measures the radiance Rbb(λ))(K_{bb}ⁱ) at the spectral resolution over the spectral band at the initial temperature (step 48). The radiance measurement is evaluated to determine whether it lies above or below the radiance measurement of the unknown IR source over the spectral band (step 50). This step may be performed by the processor or a technician. This information is used to select another temperature (step 52). The process is repeated until the radiance measurements of the plate blackbody bracket the radiance measurements of the unknown IR source, and preferably until there are at least two measurements above and at least two measurements below those of the unknown IR source.

Once bracketed, processor 20 processes each unknown relative radiance array into relative radiance (step 53). For each wavelength over the spectral band, the processor 20 calculates an absolute radiance Lbb(λ)(K_{bb}ⁱ) of the characterized blackbody at each of the different temperatures K_{bb}ⁱ that is retained according to equation 1 (step 54). The absolute radiance has a first component that is a function of the thermal temperature K_{bb}ⁱ of the plate blackbody and represents the emissions of the blackbody and a second component that is a function of the ambient temperature K_{amb} and represents the ambient radiance that is reflected off of the blackbody. Both terms are a function of the emissivity of the plate blackbody reflected in the correction terms. For near perfect blackbodies, the second term is less than 1%. However, for plate blackbodies the term may represent 5% of the signal and thus should be included to achieve accurate results.

$$Lbb ( λ ) ( {K}_{{bb}^{i}} ) = \frac{1}{π} \{ ( \frac{C 1}{{λ}^{5} {e}^{\frac{C 2}{λ {K}_{{bb}^{i}}}} - 1} \times {Emiss}_{λ} ) + ( \frac{C 1}{{λ}^{5} {e}^{\frac{C 2}{λ {K}_{amb}}} - 1} \times ( 1 - {Emiss}_{λ} ) ) \} \\ {Emiss}_{λ} = ( 0 < Emissivity < 1 ) at λ \\ C 1 = 2 \times h \times π \times {c}^{2} \times {10}^{20} = Planck ' s Constant 1 for μ m \\ C 2 = \frac{c \times h}{k} \times {10}^{6} = Planck ' s Constant 2 for μ m . \qquad Eqn . 1$$

In this embodiment, the absolute radiance of the plate blackbody is converted to an effective temperature K,(λ) (step 56) according to equation 2.

$${K}_{i} ( λ ) = \frac{C 2}{λ \times ln ( \frac{C 1}{π \times {λ}^{5} \times {L}_{{bb}^{λ}}} )} \qquad Eqn . 2$$

Although not required, this serves to linearize the absolute radiance measurements of the plate blackbody, which in turn will improve the accuracy of the final characterization.

Each effective temperature Kᵢ(λ)(K_{bb}ⁱ) is paired with the relative radiance Rbb(λ)(K_{bb}ⁱ) for each of the temperatures to create a two-dimensional matrix (step 58).

The processor 20 selects a first wavelength (step 60), interpolates the effective temperature Kᵢ(λ) from the pairs (Rbb(λ)(K_{bb}ⁱ), Kᵢ(λ) (K_{bb}ⁱ)) 61 in the two-dimensional matrix that bracket the relative radiance Rs(λ) 63 to derive an effective temperature K_{sλ} for the unknown IR source (step 62). Both a linear interpolation 64 and a nonlinear interpolation 66 of the 4 data points are depicted. The effective temperature Kₛ(λ) is determined by reading out the value of the linear or nonlinear interpolation at the relative radiance 63 of the unknown IR source. The processor increments through each wavelength over the spectral band (step 68) to produce an array of effective temperatures for the unknown IR source.

At this point it is important to understand how accurately the measurement needs to be made. For uncertainties of 3% or more, 2 measurements, bounding the unknown, is acceptable. If maximum accuracy (1% or better) is required then either the temperature difference between any 2 measurements must be 5 degrees or less (allowing a piecemeal linear interpolation) or no less than 4 measurements must be used so a nonlinear interpolation can be applied.

The processor converts the effective temperatures for the unknown IR sources back to an absolute radiance Ls (λ) 70 according to equation 3 (step 72) to characterize the source.

$$Ls ( λ ) = \frac{C 1}{{λ}^{5} \times {e}^{\frac{C 2}{λ \times {K}_{S} ( λ )}} - 1} \qquad Eqn . 3$$

The absolute radiance does not have to be converted to an effective temperature prior to interpolation. In an alternate embodiment, the absolute radiances from the pairs (Rbb(λ)(K_{bb}ⁱ), Lbb(λ)(K_{bb}ⁱ)) that bracket the relative radiance Rs(λ) are interpolated to directly derive an absolute radiance Rs(λ) for the unknown IR source. This may produce slightly inferior results from the interpolation process but avoids the computations associated with converting back-and-forth between the effective temperature.

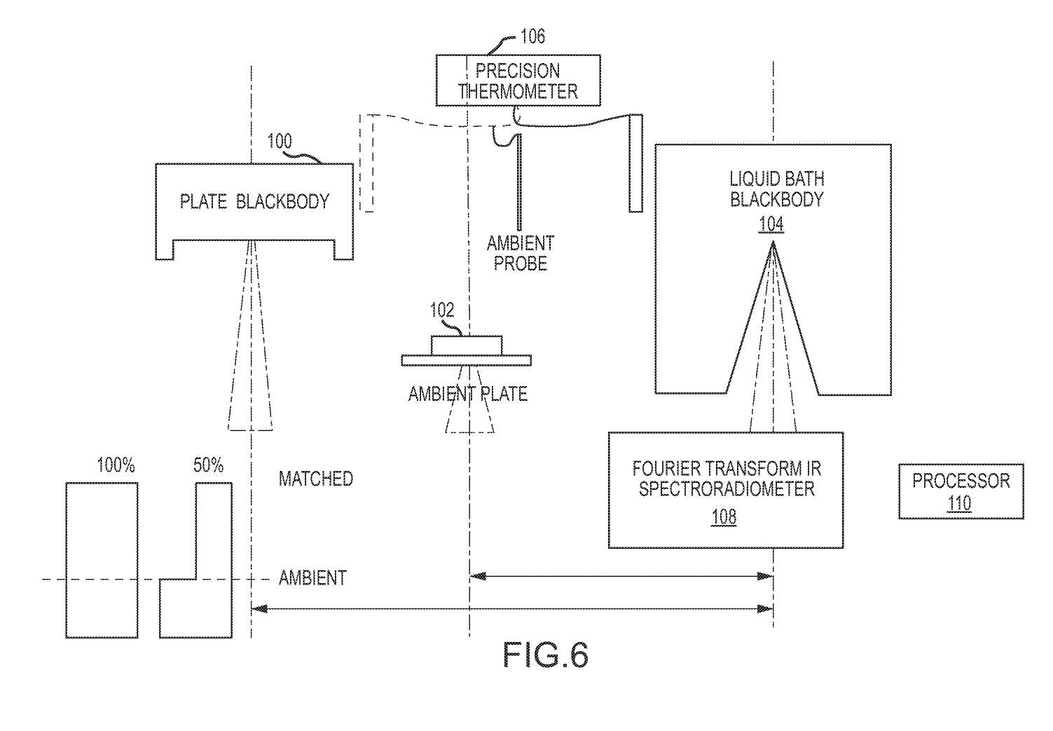

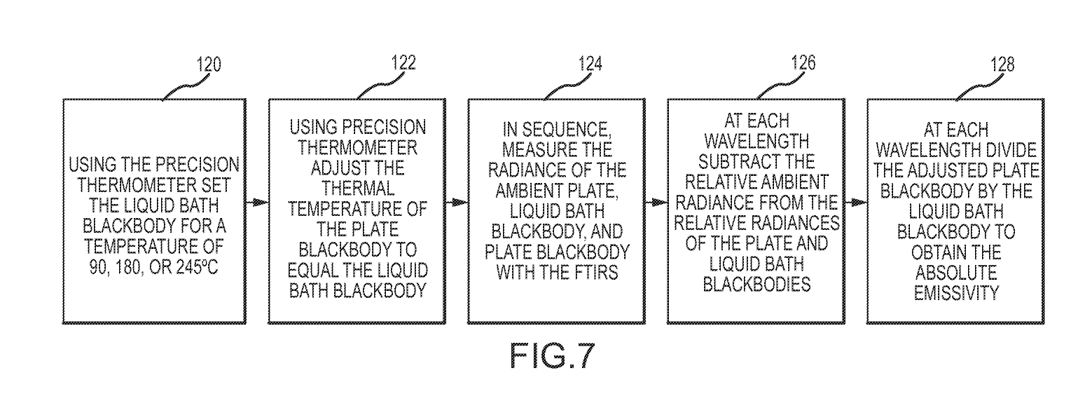

Referring now to FIGS. 6-7, in an embodiment a test configuration for characterizing a plate blackbody 100 comprises the plate blackbody 100, an ambient plate 102 (e.g., a blackened metal plate that approximates a Planckian radiator), and a liquid bath blackbody 104, a thermometer 106 configured to measure an ambient temperature, a plate blackbody temperature, and a liquid bath blackbody temperature, an FTIRS 108 to measure the relative radiances of the plate blackbody, ambient plate and liquid bath blackbody and a processor 110 configured to process measured temperatures and relative radiances to characterize the emissivity of the plate blackbody against that of the liquid bath blackbody.

The plate blackbody is characterized by comparing the relative radiances of the almost perfect Planckian radiator (liquid bath blackbody) and the plate blackbody and correcting for the offset that exists in the “ambient” portion of the energy distribution to generate a correction that applies over a fairly broad range of temperatures allowing the exact radiance emitted from the plate blackbody to be known. This allows even plate blackbodies to emit known levels of optical energy to accuracies unobtainable except for the most accurate cavity blackbodies.

More particularly, the same thermometer is used to set a liquid bath blackbody to a specified temperature (step 120) and to adjust the thermal temperature of a plate blackbody to equal the temperature of the liquid bath blackbody (step 122). The relative radiance is measured at a plurality of wavelengths over a specified spectral band of an ambient plate, the liquid bath blackbody and the plate blackbody (step 124). At each wavelength, the relative radiance of the ambient plate is subtracted from the relative radiances of the liquid bath blackbody and the plate blackbody, respectively, to provide adjusted liquid bath and plate blackbody relative radiances (step 126). The adjusted plate blackbody relative radiance is divided by the adjusted liquid bath blackbody radiance to provide an absolute emissivity to characterize the plate blackbody (step 128). The absolute emissivities are output as a correction array for the plate blackbody such that the plate blackbody approximates the characterization of the liquid bath blackbody.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

I claim:

1. A method of measuring absolute spectral radiance of an unknown IR source, comprising:
measuring a relative radiance Rs(λ) of the unknown IR source at a plurality of wavelengths over a specified spectral band;
measuring a relative radiance Rbb(λ)(K_{bb}ⁱ) of a characterized blackbody at the plurality of wavelengths over the specified spectral band at different thermal blackbody temperatures K_{bb}ⁱ, K_{bb}². . . to bracket the relative radiance Rs(λ) of the unknown IR source over the spectral band; and
at each wavelength,
calculating an absolute radiance Lbb(λ)(K_{bb}^{I}) of the characterized blackbody at each of the different temperatures K_{bb}ⁱ;
pairing the absolute radiance Lbb(λ)(K_{bb}ⁱ) with the relative radiance Rbb(λ)(K_{bb}ⁱ) for each of the temperatures; and
interpolating the absolute radiance from the pairs (Rbb(λ)(K_{bb}ⁱ), Lbb(λ)(K_{bb}^{I})) that bracket the relative radiance Rs(λ) to derive an absolute radiance Rs(λ) for the unknown IR source.

2. The method of claim 1, wherein the characterized blackbody is characterized from at least 3 to 14.15 microns and is valid over a temperature range of the blackbody that spans at least 250 to 673 K, wherein the specified spectral band is within the MIR (3-5 microns) and LWIR (5-15 microns) interval and the plurality of wavelengths have a wavelength resolution of at least 10 nm.

3. The method of claim 1, wherein the measurements of relative radiance are made with a spectroradiometer that provides the measurements at each of the plurality of wavelengths over the specified spectral band.

4. The method of claim 3, wherein the spectroradiometer is a Fourier Transform Infrared (FTIR) spectroradiometer.

5. The method of claim 1, wherein the characterized blackbody comprises a characterized plate blackbody, further comprising using a correction array for the plate blackbody to calculate the absolute radiance of the characterized plate blackbody.

6. The method of claim 5, wherein the plate blackbody is characterized by using a thermometer to set a liquid bath blackbody to a specified temperature;
using the same thermometer to adjust the thermal temperature of a plate blackbody to equal the temperature of the liquid bath blackbody;
measuring the relative radiance at a plurality of wavelengths over a specified spectral band of an ambient plate that approximates a Plankian radiator, the liquid bath blackbody and the plate blackbody;
at each wavelength,
subtracting the relative radiance of the ambient plate from the relative radiances of the liquid bath blackbody and the plate blackbody, respectively, to provide adjusted liquid bath and plate blackbody relative radiances; and
dividing the adjusted plate blackbody relative radiance by the adjusted liquid bath blackbody radiance to provide an absolute emissivity to characterize the plate blackbody; and
outputting the absolute emissivities as the correction array for the plate blackbody such that the plate blackbody approximates the characterization of the liquid bath blackbody.

7. The method of claim 1, wherein the characterized blackbody comprises a characterized plate blackbody and wherein the measurements of relative radiance are made with a Fourier Transform Infrared (FTIR) spectroradiometer.

8. The method of claim 6, wherein the unknown IR source is fully characterized over a spectral band spanning at least 5 microns with a spectral resolution of at least 10 nm in less than two hours.

9. The method of claim 1, wherein the absolute radiance of the characterized blackbody is calculated as a function of the thermal temperature of the blackbody (K_{bb}ⁱ) and an ambient temperature K_{amb}.

10. The method of claim 1, wherein the relative radiance of the characterized blackbody is measured at different temperatures to provide at least two measurements above and two measurements below the relative radiance measurements of the unknown IR source across the spectral band.

11. The method of claim 10, wherein the interpolation comprises a non-linear interpolation.

12. The method of claim 1, further comprising at each wavelength,
converting the absolute radiance of the characterized blackbody at each of the different temperatures to an effective temperature Kᵢ(λ);
interpolating the effective temperature Kᵢ(λ) from the pairs (Rbb(λ)(K_{bb}ⁱ), Kᵢ(λ) (K_{bb}ⁱ)) that bracket the relative radiance Rs(λ) to derive an effective temperature Kₛ(λ) for the unknown IR source; and
calculating an absolute radiance Ls (λ) from the temperature Kₛ(λ).

13. A method of measuring absolute spectral radiance of an unknown IR source, comprising:
loading a correction array for a characterized plate blackbody;
configuring a Fourier Transform Infrared Spectroradiometer (FTIRS) to measure relative radiance within a field-of-view (FOV);
measuring ambient temperature;
using the FTIRS to measure a relative radiance Rs(λ) of the unknown IR source at a plurality of wavelengths over a specified spectral band, wherein the unknown IR source overfills the FOV;
using the FTIRS to measure a relative radiance Rbb(λ)(K_{bb}ⁱ) of a characterized blackbody at the plurality of wavelengths over the specified spectral band at different thermal blackbody temperatures K_{bb}¹, K_{bb}². . . to bracket the relative radiance Rs(λ) of the unknown IR source over the spectral band; and
at each wavelength,
calculating an absolute radiance Lbb(λ)(K_{bb}ⁱ) of the characterized blackbody at each of the different temperatures K_{bb}ⁱ;
pairing the absolute radiance Lbb(λ)(K_{bb}ⁱ) with the relative radiance Rbb(λ)(K_{bb}ⁱ) for each of the temperatures; and
interpolating the absolute radiance from the pairs (Rbb(λ)(K_{bb}ⁱ), Lbb(λ)(K_{bb}ⁱ)) that bracket the relative radiance Rs(λ) to derive an absolute radiance Rs(λ) for the unknown IR source.

14. The method of claim 13, wherein the unknown IR source is fully characterized over a spectral band spanning at least 5 microns with a spectral resolution of at least 10 nm in less than two hours.

15. The method of claim 13, wherein the relative radiance of the characterized blackbody is measured at different temperatures to provide at least two measurements above and two measurements below the relative radiance measurements of the unknown IR source across the spectral band.

16. The method of claim 1, further comprising at each wavelength,
converting the absolute radiance of the characterized blackbody at each of the different temperatures to an effective temperature Kᵢ(λ);
interpolating the effective temperature Kᵢ(λ) from the pairs (Rbb(λ)(K_{bb}ⁱ), Kᵢ(λ) (K_{bb}ⁱ)) that bracket the relative radiance Rs(λ) to derive an effective temperature Kₛ(λ) for the unknown IR source; and
calculating an absolute radiance Ls (λ) from the temperature Kₛ(λ).

17. A method of characterizing a plate blackbody, comprising:
using a thermometer to set a liquid bath blackbody to a specified temperature;
using the same thermometer to adjust the thermal temperature of a plate blackbody to equal the temperature of the liquid bath blackbody;
measuring the relative radiance at a plurality of wavelengths over a specified spectral band of an ambient plate that approximate a Planckian radiator, the liquid bath blackbody and the plate blackbody;
at each wavelength,
subtracting the relative radiance of the ambient plate from the relative radiances of the liquid bath blackbody and the plate blackbody, respectively, to provide adjusted liquid bath and plate blackbody relative radiances; and
dividing the adjusted plate blackbody relative radiance by the adjusted liquid bath blackbody radiance to provide an absolute emissivity to characterize the plate blackbody; and
outputting the absolute emissivities as a correction array for the plate blackbody such that the plate blackbody approximates the characterization of the liquid bath blackbody.

18. The method of claim 7, wherein the characterized plate blackbody is characterized from at least 3 to 14.15 microns and is valid over a temperature range of the blackbody that spans at least 250 to 673 K.
